(19) United States
(12) Patent Application Publication
(10) Pub. No.: US 2021/0022363 A1
(43) Pub. Date: Jan. 28, 2021

(54) POWDERED BEVERAGE COMPRISING GLYCOLIPIDS

(71) Applicant: SOCIETE DES PRODUITS NESTLE S.A., Vevey (CH)

(72) Inventors: John Craven, Lausanne (CH); Bruno Edgar Chavez Montes, Lausanne (CH)

(21) Appl. No.: 17/043,098

(22) PCT Filed: May 20, 2019
(86) PCT No.: PCT/EP2019/062914

§ 371 Date: Sep. 29, 2020

(30) Foreign Application Priority Data
May 22, 2018 (EP) 18173557.2

(51) Int. Cl. A23G 1/56; A23L 2/39; A23L 2/66

(52) U.S. Cl. CPC A23G 1/56; A23V 2002/00; A23L 2/66; A23L 2/39

(57) ABSTRACT

The present invention relates to powdered beverages. In particular to a powdered beverage comprising glycolipids and a fat having a melting point above 20° C. Further aspects of the invention are a process for manufacturing a powdered beverage and the use of glycolipids to reduce the reconstitution time of a beverage powder, for example after storage.

### FIELD OF THE INVENTION

The present invention relates to powdered beverages. In particular to a powdered beverage comprising glycolipids and a fat having a melting point above 20° C. Further aspects of the invention are a process for manufacturing a powdered beverage and the use of glycolipids to reduce the reconstitution time of a beverage powder, for example after storage.

### BACKGROUND OF THE INVENTION

A growing number of beverage products have been developed and commercialized in a powdered form. Such products include coffee and coffee-based beverages (e.g. cappuccino), coffee and tea creamers, cocoa powders, malt beverages, milk powders, soups and infant formulas. This trend is mainly linked to the convenience offered by powders, their chemical and microbiological stability and reduced transport costs. At the consumer level, rapid and complete reconstitution of these dehydrated products is one of the main quality indicators. The reconstitution time is defined as the time needed to transform a powder into solution. In general, the aim is to shorten the reconstitution time. Powders that disperse in both hot and cold water with a minimum of stirring and without the formation of lumps or undissolved sediments are referred to as ‘instant’ powders.

Many beverage powders contain fat, for example milk powders and cocoa beverages, and when crystalline fat is present on the powder particles' surface it can reduce the wettability of the powder and so increase reconstitution time. Generally, the reconstitution time of beverage powders increases during storage, presenting a quality defect which limits on-pack “best-before” dates.

Soy lecithin has been used for many years to improve beverage powder reconstitution. However, some consumers would prefer not to consume products containing soy ingredients, for example due to a desire to avoid eating ingredients that may originate from genetically modified crops. This desire to avoid genetically modified ingredients can lead to even non-genetically modified ingredients (e.g. non GMO soy) being avoided by association. Replacing soy lecithin in beverage powders is not straightforward, for example the use of sunflower lecithin provides a beverage powder which reconstitutes well when initially manufactured but, after storage of the powder, the reconstitution time increases so as to compare unfavorably with an equivalent soy lecithin powder.

More and more consumers are concerned by additives that may be perceived as synthetic or artificial in food products. Thus, there is a demand for commercially available beverage powders without such additives. Often, beverage powders contain stabilizers such as hydrocolloids, mono or diglyceride emulsifiers, or synthetic emulsifiers that may not be perceived as natural by the consumers. These perceived artificial food ingredients, however, are typically needed to guarantee storage stability and good reconstitution of the beverage powder.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

### SUMMARY OF THE INVENTION

An object of the present invention is to improve the state of the art and to provide an alternative beverage powder composition to overcome at least some of the inconveniences described above. The object of the present invention is achieved by the subject matter of the independent claims. The dependent claims further develop the idea of the present invention.

When seeking to replace soy lecithin in powdered beverages you might consider using sunflower lecithin. The phospholipid composition of lecithins from soy and sunflower are very similar, and when applied to a glass slide and a droplet of water added, the observed contact angles for soy and sunflower lecithins were found to be very similar (FIG. 1). However, the reconstitution times of fat-containing beverage powders were found to be unacceptably long for powders made with sunflower lecithin, especially after prolonged storage of the powder (FIG. 2). Investigating this phenomenon, the inventors found that soy and sunflower lecithins have different effects on the phase behavior of fats. Using cocoa butter as the fat, soy lecithin was found to cause the fat to form discrete, small, round crystals with minimal surface area. By contrast, sunflower lecithin causes cocoa butter to form large, dendritic crystals with substantial surface area (FIGS. 3, 4 & 5). Without wishing to be bound by theory, the inventors believe that the formation of large crystals and gel-like phase traps polar lipids, preventing them from being able to reduce surface tension when the powder is in contact with water.

Thus, a replacement for soy lecithin must do two things: 1) emulsify (lower surface tension) and 2) modify fat crystallization behavior in a favorable way. While many surfactants influence one of these factors it is challenging to find a candidate that has a positive effect on both (i.e. emulsification and crystal habit modification) and is well perceived by consumers. The inventors were surprised to find that oat oil rich in glycolipids had a positive effect on both factors. Oat oil rich in glycolipids caused fat to form discrete, small, round crystals with minimal surface area (FIG. 6). When used to replace soy lecithin in a beverage powder formulation, the oat oil rich in glycolipids was found to reduce the time taken for reconstitution, even after storage of the powder.

Accordingly, the present invention provides in a first aspect a powdered beverage comprising lipids wherein at least 3.5 wt. % of the lipids are glycolipids and wherein the lipids comprise a fat having a melting point above 20° C.

In a second aspect, the invention relates to a process for manufacturing a powdered beverage, the process comprising preparing a composition comprising a polyol, a protein-containing powder and lipids, wherein at least 2.5 wt. % of the lipids are glycolipids and at least 30 wt. % of the lipids are fat having a melting point above 20° C.

A third aspect of the invention relates to the use of glycolipids to reduce the reconstitution time of a beverage powder.

### BRIEF DESCRIPTION OF THE DRAWINGS

FIG. 1. Contact angles measured using distilled water for soy □ and sunflower ▪ lecithins applied to glass slides and stored (ambient conditions) for 4 and 90 hours. When a water droplet is applied to the sample the initial contact angle is measured; when the contact angle reaches a steady value the final contact angle is recorded.

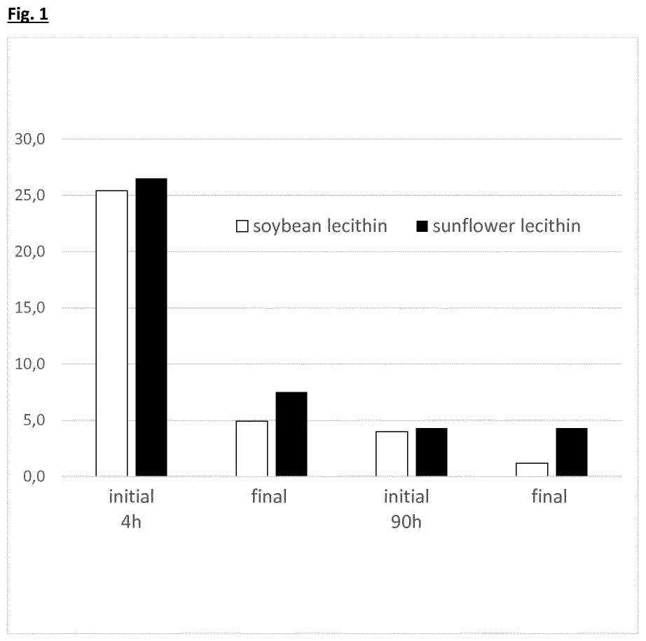

FIG. 2. Wettability as a function of time for a cold-reconstitutable cocoa powder beverage prepared with soy (circles) and sunflower lecithin (squares).

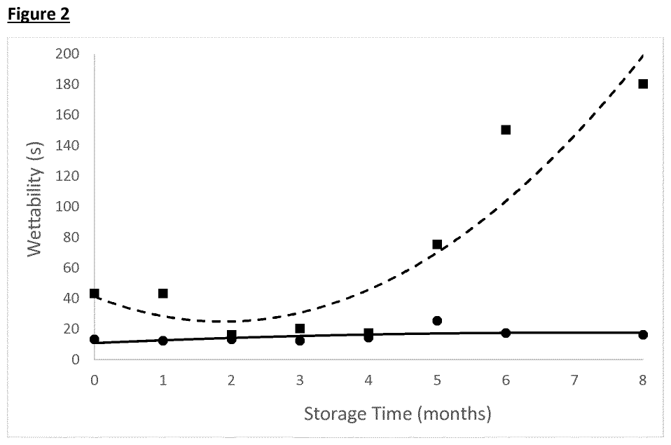

FIG. 3. Polarized light micrographs (100× magnification) for soy lecithin/cocoa butter (1:1) stored at 25° C. for (a & b) 24 hours, (c & d) 6 weeks, (e & f) 10 weeks, (g & h) 20 weeks

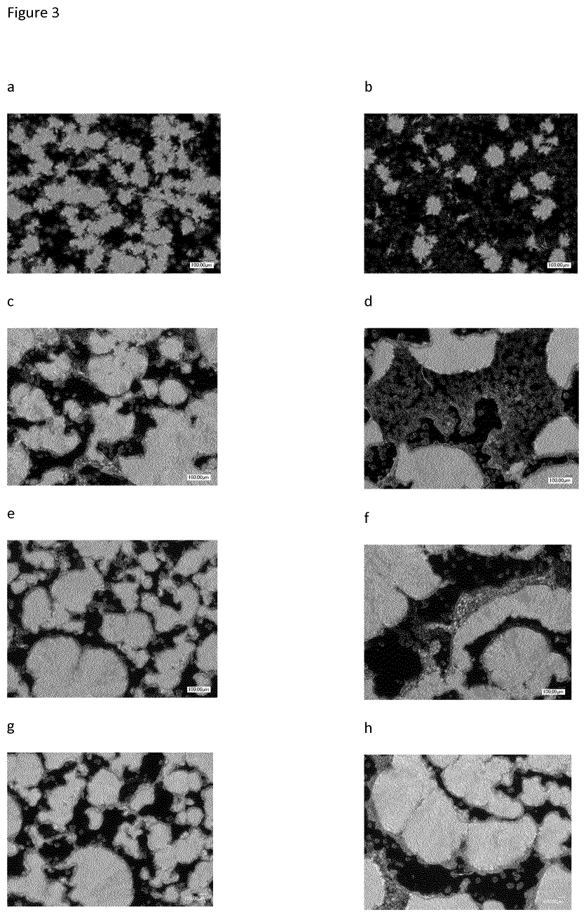

FIG. 4. Polarized light micrographs (100× magnification) for sunflower lecithin/cocoa butter (1:1) stored at 25° C. for (a & B) 24 hours, (c & d) 6 weeks, (e & f) 10 weeks, (g & h) 20 week

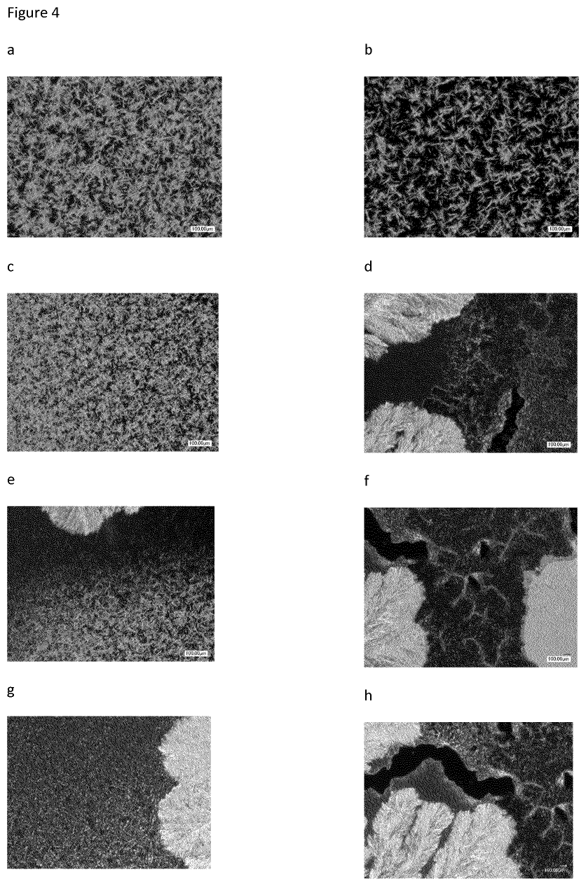

FIG. 5. Cryo-Scanning Electron Micrographs with lower (left) and higher (right) magnification for 4 week old samples stored at 25° C.: (a & b) soy lecithin/cocoa butter (1:1) and (c & d) sunflower lecithin/cocoa butter (1:1).

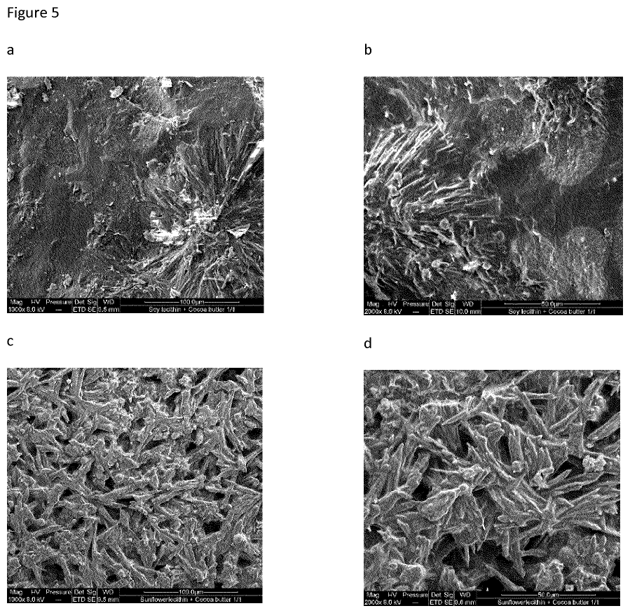

FIG. 6. Polarized light micrographs (100×) for oat oil with polar lipid concentrations of 30 and 40% (left and right, respectively) in oat oil/cocoa butter (1:1) blend after storage at 25° C. for a-b) 5 days, c-d) 5 weeks, and e-f) 7 months.

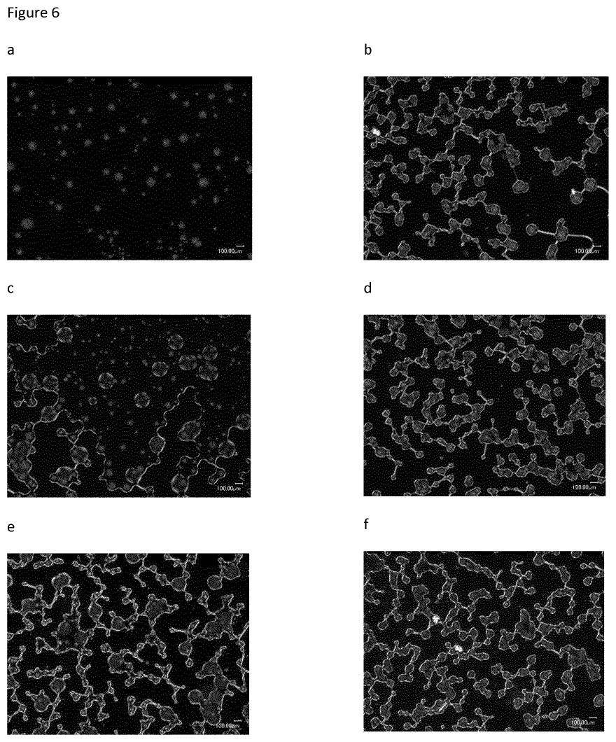

### DETAILED DESCRIPTION OF THE INVENTION

Consequently the present invention relates in part to a powdered beverage comprising lipids wherein at least 3.5 wt. % (for example at least 4 wt. %, for example at least 4.5 wt. %, for example at least 5 wt. %, for example at least 5.5 wt. %, for further example at least 6 wt. %) of the lipids are glycolipids and wherein the lipids comprise a fat having a melting point above 20° C. In an embodiment the powdered beverage comprises between 0.5 and 50 wt. % lipid, for example between 1 and 40 wt. %, for further example between 5 and 35 wt. % lipid.

In an embodiment, the powdered beverage comprises lipids wherein between 4 wt. % to 7 wt. % of the lipids are glycolipids, more preferably between 5 wt. % to 7 wt. % of the lipids are glycolipids, more preferably between 6 wt. % to 7 wt. % of the lipids are glycolipids, and wherein the lipids comprise a fat having a melting point above 20° C.

Glycolipids are polar lipids, the lipid molecule containing a carbohydrate group. The glycolipids according to the powdered beverage of the invention may comprise galactolipids. The carbohydrate group of a galactolipid being galactose. In an embodiment of the powdered beverage of the invention, at least 2 wt. % of the lipids are galactolipids, for example at least 3 wt. %, for example at least 3.5 wt. %, for example at least 4 wt. %, for example at least 4.5 wt. %, for example at least 5 wt. %, for example at least 5.5 wt. %, for further example at least 6 wt. % of the lipids are galactolipids. The galactolipids may comprise digalactosyldiglycerides (estolides and non-estolides), for example at least 1.5 wt. % of the lipids comprised within the powdered beverage of the invention may be digalactosyldiglycerides, for example at least 3 wt. %, at least 3.5 wt. %, at least 4 wt. %, at least 4.5 wt. %, at least 5 wt. %, at least 5.5 wt. % or at least 6 wt. % of the lipids may be digalactosyldiglycerides.

Without wishing to be bound by theory, the inventors believe that glycolipids, when present in a sufficient amount, not only act as emulsifiers but are able to modify the crystal habit of fats present in a powdered beverage. The reconstitution of powders containing fats may be impaired by the presence of fat on the surface of the powder, especially when the surface fat has crystallized. Fats may move to the surface of the powder during manufacture. For example when the powder is heated during drying or steam agglomeration. Fats likely to be present in a crystalline form on the powder surface at ambient conditions are those with a melting point above 20° C. In an embodiment of the invention, the lipids comprise a fat having a melting point above 27° C. The fat having a melting point above 20° C. (for example above 27° C.) may be present at a level of at least 30 wt. % on a total lipid basis, for example at least 40, 50, 60, or 70 wt. % on a total lipid basis. The fat having a melting point above 20° C. may be selected from the group consisting of milk fat, cocoa butter, palm fat, ilipe butter, shea butter, kokum butter, sal fat, coconut fat, palm kernel oil and fractions of these. The fat having a melting point above 20° C. may be cocoa butter. The fat having a melting point above 20° C. may be milk fat.

In the context of the present invention, the term fat refers to triglycerides. Fats are the chief component of animal adipose tissue and many plant seeds. Fats which are generally encountered in their liquid form are commonly referred to as oils. In the present invention the terms oils and fats are interchangeable. The melting point of a fat may for example be the lowest temperature at which it has less than 1% solid fat content. The solid fat content may be measured by pulsed NMR, for example according to the IUPAC Method 2.150 b (special thermal pretreatment) [IUPAC, Standard Methods for the Analysis of Oils, Fats and Derivatives, 7th Revised and Enlarged Edition (1987)].

The solid fat content of the powder at 20° C. may be greater than 30% of the total fat present, for example greater than 40% of the total fat present, for further example greater than 50% of the total fat present. This may for example be measured by NMR, recording the free induction decay of a powder sample, followed by a fat extraction to quantify the total fat present.

At least 40 wt. % of the total fat comprised as part of the powdered beverage of the invention may be surface free fat, for example at least 50 wt. %, for further example at least 60 wt. %. In the content of the present invention, surface free fat is fat which is on the surface of the powder matrix. Surface free fat may be determined as for surface free fat in infant formula, using the method of Tham et al. [T.W.Y. Tham et al., Food Chemistry, 218, 30-39 (2017).] Free fat is able to move to the surface of the powder during processing, and free fats may crystallize on the surface leading to problems of 3.0 reconstitution, so it is beneficial that the powdered beverage of the invention is able to reduce such crystallization and so enhance reconstitution.

The glycolipids according to the invention may be from fractionated oils. The glycolipids according to the invention may be from edible plants. The glycolipids (for example galactolipids) may be obtained from plants in the group consisting of oats; legumes (e.g., common bean, pea); leaf vegetables (e.g., kale, leek, parsley, perilla and spinach); stem vegetables (e.g., asparagus, broccoli, Brussels sprouts); and fruit vegetables (e.g., chili, bell pepper, pumpkin). The glycolipids according to the invention may be from spinach. In an embodiment of the invention, the glycolipids originate from oats, for example they may be comprised within oat oil, for example fractionated oat oil.

Examples of sources of glycolipids that can be used in the invention are the following oat oils: SWEOAT Oil PL4, SWEOAT Oil PL15 or SWEOAT Oil PL40.

SWEOAT Oil PL4 comprises the following per 100 grams: Fat 99 g, comprising 4 g of polar lipids and 95 g of neutral lipids; saturated fatty acids 17 g; monounsaturated fatty acids 37 g, polyunsaturated fatty acids 45 g.

SWEOAT Oil PL15 comprises the following per 100 grams: Fat 97 g, comprising 15 g of polar lipids and 82 g of neutral lipids; saturated fatty acids 17 g; monounsaturated fatty acids 37 g; polyunsaturated fatty acids 45 g.

SWEOAT Oil PL40 comprises the following per 100 grams: Fat 98 g, comprising 40 g of polar lipids and 58 g of neutral lipids.

In one embodiment, a source of glycolipid used in the invention is an oat oil, wherein said oat oil comprises the following per 100 grams: Fat 97 g to 99 g, comprising 4 g to 40 g of polar lipids and 58 g to 95 g of neutral lipids.

In one embodiment, a source of glycolipid used in the invention is an oat oil, wherein said oat oil comprises the following per 100 grams: Fat 98 g, comprising 40 g of polar lipids and 58 g of neutral lipids.

In one embodiment, the glycolipids may be comprised within oat oil which has been processed using low temperature high vacuum distillation, for example low temperature high vacuum thin film distillation.

It is known that oil blends created with oat oil extract have: i) a strong negative odour, ii) a strong dark colour and iii) an off-taste. These are undesirable properties that make products prepared using an oat based oil blend un-appealing to consumers. Therefore it is preferable that oat oil is refined prior to use to remove contaminants that adversely impact the appearance and performance.

The bleaching of edible oils and fats is a part of the refining process of crude oils and fats and is generally preceded by degumming and neutralization processes. Bleaching is required to remove specific detrimental contaminants that are not effectively removed by these processes before the oil progresses through deodorisation.

Processes for carrying out degumming, bleaching, deodorisation and fractionation are well known in the art.

Deodorisation is a stripping process in which a given amount of a stripping agent (usually steam) is passed for a given period of time through hot oil at a low pressure. Hence, it is mainly a physical process in which various volatile components are removed.

Existing solutions to deodorising/decolouring of oils consist of standard bleaching and deodorising at elevated temperatures (e.g., 230-260° C.). Standard deodorisation is not suitable for oils rich in glycolipids as the temperatures used lead to colour and taste degradation of the oil. For example, high temperature lead to the creation of a black pigment/gum which leads to spoilage of the oil blend. This pigment also leads to the creation of a burn/caramel aroma/taste which is un-appealing.

Surprisingly, using low temperature high vacuum thin film distillation for deodorising/decolouring oils rich in glycolipids such as oat oil leads to an oil that has no odour, dark colour or off-taste.

Low temperature high vacuum distillation is a method of distillation performed under reduced pressure. A reduced pressure decreases the boiling point of compounds, allowing for a reduced temperature to be used. This is advantageous if the desired compounds are thermally unstable and decompose at elevated temperatures. Oat oil blends contain compounds which are thermally unstable and form black pigment/gum when standard bleaching and deodorising is carried out at elevated temperatures. However, surprisingly, this can be avoided by using low temperature high vacuum distillation.

For example, a short-path distillation device such as UIC KDL-5 (UIC GmbH, Alzenau-Hörstein, Germany) may be used with the following conditions: pressure=0.001 to 0.03 mbar and temperature 60° to 70° C. Conditions being chosen to achieve required viscosity and avoid chemical damage to oat oil. The oat oil may be processed as such or, in an alternate process, oat oil with 40% polar lipids may be first diluted with refined vegetable oil in ratio 1:1. One to three sequential passes of short-path distillation may be applied to achieve required quality. Sensory discriminatory testing shows that oat oil processed in this manner does not have the strong negative odour associated with un-processed oat oil.

Accordingly, low temperature high vacuum distillation may be used to efficiently produce an oat oil comprising glycolipids that has no odour, dark colour or off-taste.

The powdered beverage of the invention may be an agglomerated powder. Agglomeration improves powder handling and dissolution. The powdered beverage of the invention may be an agglomerated powder having a particle size distribution D_{4,3} greater than 250 microns. The term “D_{4,3} particle size distribution” is used conventionally in the present invention and is sometimes called the volume mean diameter. The D_{4,3} values may be measured for example by a laser light scattering particle size analyser. The powdered beverage of the present invention may have a low level of fine particles. For example, the powder may have less than 20%, for example less than 15% of particles smaller than 100 microns.

The powdered beverage of the invention may comprise at least 1 wt. % protein, for example at least 2 wt. % protein, for further example at least 3 wt. % protein. The powdered beverage of the invention may comprise milk protein, for example whey protein or casein; or plant protein, for example cocoa protein. It is advantageous that the powdered beverage of the invention provides good reconstitution even when comprising proteins which are often difficult to dissolve or disperse.

In an embodiment, the powdered beverage of the invention comprises vitamins and/or minerals. The powdered beverage may comprise carbohydrates. The powdered beverage may comprise at least 60 wt. % carbohydrates, for example water-soluble or water-dispersible dietary fibre and/or polyols such as sugars (for example sucrose and/or lactose).

The powdered beverage of the invention may be dissolvable or dispersible in hot liquid, for example water or milk. The powdered beverage may be a hot chocolate drink. The powdered beverage may be a beverage creamer.

It is advantageous that the invention provides a powdered beverage that may be dissolved or dispersed in cold liquid. Dispersion in cold liquids presents a particular technical challenge, especially for beverage powders that comprise solid fat and/or protein. The powdered beverage of the invention may be dissolvable or dispersible in cold liquid, for example water or milk. The powdered beverage may be a cold liquid dispersible cocoa beverage. In an embodiment, the powdered beverage of the invention is a cocoa beverage; that is a beverage comprising cocoa powder, such as fat-reduced cocoa powder comprising between 9 and 13 wt. % fat.

In an embodiment, the powdered beverage of the invention is free from soy lecithin. In an embodiment, the powdered beverage of the invention is free from sunflower lecithin. In an embodiment, the powdered beverage of the invention does not comprise any additional emulsifiers such as low molecular weight emulsifiers. By a low molecular weight emulsifier is meant an emulsifier with a molecular weight below 1500 g/mol. For example, the powdered beverage may not comprise an emulsifier selected from the group consisting monoglycerides, diglycerides, acetylated monoglycerides, sorbitan trioleate, glycerol dioleate, sorbitan tristearate, propyleneglycol monostearate, glycerol monooleate and monostearate, sorbitan monooleate, propylene glycol monolaurate, sorbitan monostearate, sodium stearoyl lactylate, calcium stearoyl lactylate, glycerol sorbitan monopalmitate, diacetylated tartaric acid esters of monoglycerides, succinic acid esters of mono- and/or diglycerides, lactic acid esters of mono- and/or diglycerides, and sucrose esters of fatty acids, and combinations thereof.

In an embodiment, between 0.1 to 20 wt % of the lipids in the powdered beverage of the present invention are polar lipids. The polar lipids may be heterolipids.

For example, 2 to 18 wt %, 5 to 16 wt %, 10 to 14 wt % of the lipids in the powdered beverage may be polar lipids.

For example at least 15, 20, 25, 30, 35, 40, 45 or 50 wt % of the polar lipids in the powdered beverage may be glycolipids.

For example at least 5, 10, 15, 20 or 25 wt % of the polar lipids in the powdered beverage may be galactolipids.

For example at least 5, 10, 15, 20 or 25 wt % of the polar lipids in the powdered beverage are digalactosyldiacylglycerides.

The polar lipids in the powdered beverage may also comprise phospholipids.

In one embodiment, less than 85, 80, 60, 40, 20, 15, 10, 8, 6, 4 or 2 wt % of the polar lipids in the powdered beverage of the invention may be phospholipids.

For example the polar lipids in the powdered beverage of the invention may comprise at least 15 wt % phospholipids, for example at least 16, 17, 18, 19 or 20 wt % phospholipids.

For example, the polar lipids in the powdered beverage of the invention may comprise 15 to 85 wt % phospholipids or 20 to 80 wt % phospholipids.

The powdered beverage of the invention may comprise glycolipids and phospholipids at a weight ratio of at least 1:5 glycolipids to phospholipids, for example at least 1:4, for example at least 1:3, for example at least 2:3, for example at least 1:1. The quantity of glycolipids and phospholipids may be determined by quantitative ³¹P-NMR (phospholipids) and quantitative ¹H-NMR (glycolipids) with internal standards.

The powdered beverage of the invention may comprise less than 14 wt. % phospholipids, for example less than 12 wt. % phospholipids, for example less than 10 wt. % phospholipids, for example less than 8 wt. % phospholipids, for further example less than 6 wt. % phospholipids.

An aspect of the invention provides a process for manufacturing a powdered beverage, the process comprising preparing a composition comprising protein, carbohydrate and lipids, wherein at least 3.5 wt. % (for example at least 4 wt. %, for example at least 4.5 wt. %, for example at least 5 wt. %, for example at least 5.5 wt. %, for further example at least 6 wt. %) of the lipids are glycolipids and at least 30 wt. % of the lipids are fat having a melting point above 20° C. The composition according to the process of the invention may for example comprise between 0.5 and 50 wt. % lipid, for example between 1 and 40 wt. %, for further example between 5 and 35 wt. % lipid. The composition according to the process of the invention may for example comprise between 1 and 10 wt. % protein. The composition according to the process of the invention may for example comprise between 60 and 95 wt. % carbohydrate. The carbohydrate may comprise (for example consist of) water-soluble or water-dispersible dietary fibre and/or polyols such as sugars (for example sucrose and/or lactose). The composition according to the process of the invention may comprise cocoa powder, for example fat-reduced cocoa powder comprising between 9 and 13 wt. % fat. The composition according to the process of the invention may comprise milk powder.

The powdered beverage manufactured according to the process of the invention may be free from soy lecithin. The powdered beverage manufactured according to the process of the invention may be free from sunflower lecithin. The powdered beverage manufactured according to the process of the invention may comprise glycolipids and phospholipids at a weight ratio of at least 1:5 glycolipids to phospholipids, for example at least 1:4, for example at least 1:3, for example at least 2:3, for example at least 1:1.

The glycolipids according to the process of the invention may comprise galactolipids. For example at least 2 wt. % of the lipids according to the process of the invention may be galactolipids, for example at least 3 wt. %, for example at least 3.5 wt. %, for example at least 4 wt. %, for example at least 4.5 wt. %, for example at least 5 wt. %, for example at least 5.5 wt. %, for further example at least 6 wt. % of the lipids are galactolipids. The galactolipids may comprise digalactosyldiglycerides (estolides and non-estolides), for example at least 1.5 wt. % of the lipids comprised within the powdered beverage of the invention may be digalactosyldiglycerides, for example at least 3 wt. %, at least 3.5 wt. %, at least 4 wt. %, at least 4.5 wt. %, at least 5 wt. %, at least 5.5 wt. % or at least 6 wt. % of the lipids may be digalactosyldiglycerides.

In an embodiment of the process of the invention the fat is heated to a temperature above its melting point. The fat may be heated to a temperature of at least 20° C. above its melting point, for example at least 30° C. above its melting point, for example at least 40° C. above its melting point, for example at least 60° C. above its melting point, for further example at least 80° C. above its melting point. Many different process activities may lead to heating of the fat, for example steam agglomeration or drying of the beverage components. During processing, fats present in the powdered beverage are likely to move to the surface of the powder. Although the exact mechanism for this is unknown, heat and moisture are believed to play a role. Surface fat exacerbates problems of reconstitution, so it is advantageous that the inclusion of glycolipids in the composition according to the process of the invention improves reconstitution performance, for example after fat comprised within the powdered beverage has been heated.

In an embodiment the process of the invention comprises
a. mixing a protein-containing powder, fat and glycolipids with optional milling to form a powder mix;
b. agglomerating the powder mix; and
c. optionally drying the agglomerated powder mix.

The fat may be comprised within the protein-containing powder, for example the fat in cocoa powder or non- or partially-defatted milk powder. The protein-containing powder, fat and glycolipids may further be mixed with carbohydrate. The carbohydrate may comprise (for example consist of) water-soluble or water-dispersible dietary fibre and/or polyols such as sugars (for example sucrose and/or lactose). The powder mix may for example be agglomerated with steam or with water. Agglomeration may for example be performed in a mixer or by using a fluidized bed. Where steam or water is used to agglomerate the powder mix it will generally require drying before being packed.

In an embodiment the process of the invention comprises
a. mixing a protein-containing powder and fat with optional milling to form a powder mix;
b. agglomerating the powder mix;
c. coating the powder mix with glycolipids; and
d. optionally drying the agglomerated powder mix.

The fat may be comprised within the protein-containing powder, for example the fat in cocoa powder or non- or partially-defatted milk powder. The protein-containing powder and fat may further be mixed with carbohydrate. The carbohydrate may comprise (for example consist of) water-soluble or water-dispersible dietary fibre and/or polyols such as sugars (for example sucrose and/or lactose). The powder mix may for example be agglomerated with steam or with water. Agglomeration may for example be performed in a mixer or by using a fluidized bed. Where steam or water has been used to agglomerate the powder mix it will require drying before being packed. The powder mix may be coated with glycolipids by spraying. For example, an oil rich in galactolipids may be sprayed onto the surface of the powder.

In an embodiment the process of the invention comprises
a. dissolving or dispersing a carbohydrate, protein-containing powder and fat in water;
b. spray-drying the solution or dispersion to form a powder;
c. optionally agglomerating the powder; and
d. coating the powder with glycolipids.

The fat may for example be comprised within the protein-containing powder. The agglomeration of the spray-dried powder may be performed in the spray-drier apparatus. The carbohydrate may comprise (for example consist of) water-soluble or water-dispersible dietary fibre and/or polyols such as sugars (for example sucrose and/or lactose). The powder may be coated with glycolipids by spraying. For example, an oil rich in galactolipids may be sprayed onto the surface of the powder.

In an embodiment the process of the invention comprises
a. dissolving or dispersing a carbohydrate, protein-containing powder, fat and glycolipids in water;
b. spray-drying the solution or dispersion to form a powder; and
c. optionally agglomerating the powder.

The fat may for example be comprised within the protein-containing powder. The carbohydrate may comprise (for example consist of) water-soluble or water-dispersible dietary fibre and/or polyols such as sugars (for example sucrose and/or lactose). The glycolipids will tend to move to the surface of the particles during spray-drying.

An aspect of the invention provides the use of glycolipids to reduce the reconstitution time of a beverage powder, for example after storage. The glycolipids may be used to increase the wettability of a beverage powder. The glycolipids according to the use of the invention may comprise galactolipids. For example at least 2 wt. % of the lipids according to the use of the invention may be galactolipids, for example at least 4 wt. %, for example at least 8 wt. %, for example at least 12 wt. %, for further example at least 16 wt. % of the lipids may be galactolipids. The galactolipids may comprise digalactosyldiglycerides (estolides and non-estolides), for example at least 1.5 wt. % of the lipids may be digalactosyldiglycerides, for example at least 3 wt. %, at least 6 wt. %, at least 9 wt. % or at least 12 wt. % of the lipids may be digalactosyldiglycerides. Glycolipids may for example be used to reduce the reconstitution time of a cocoa beverage, for example a cold liquid dispersible cocoa beverage.

Those skilled in the art will understand that they can freely combine all features of the present invention disclosed herein. In particular, features described for the product of the present invention may be combined with the process of the present invention and vice versa. Further, features described for different embodiments of the present invention may be combined. Where known equivalents exist to specific features, such equivalents are incorporated as if specifically referred to in this specification.

Further advantages and features of the present invention are apparent from the figures and non-limiting examples.

### Examples

### Experimental Methods

Contact angle was measured on spin-coated glass slides using deionized water and a goniometer. Microscopy samples were prepared by mixing lecithin and cocoa butter then holding in an 80° C. oven for ≥1 h. Slides were prepared using glass slides and cover slips preheated in the same oven. Prepared slides were immediately placed in an incubator at 25° C. Polarized light microscopy images were gathered using 90° polarizers (Keyence VHX-S50).

Wettability was measured by depositing 15 g of chocolate beverage powder on the surface of 200 mL of partially skimmed milk (1.5-2.6% fat) at 8° C. Wettability time was recorded when the surface of the milk was clear of suspended cocoa powder beverage; ≤45 s considered a pass. After 3 minutes, wettability was scored from A to D based on the following:

A clear surface
B <50% surface coverage
C ≥50% surface coverage
D 100% surface coverage

Thus a wettability score of A with a time of <45 s is the goal. No time is recorded for samples where powder remained on the surface of the milk after 3 minutes.

Particle size distribution was measured by laser light scattering using a Malvern Mastersizer 2000. Fines were measured as being below 91.2 μm as this is the closest value to 100 μm that the instrument uses as a size class.

Examples were prepared as follows

### Recipe:

### 790 g Sucrose

10 g polar lipid containing material
200 g Cocoa Powder (10-12% fat)
Oat oils (SWEOAT) were supplied by Swedish Oat Fiber (Naturex). Sunflower lecithins were from Bunge and Cargill.

### Preparation

### Mixing & Milling

Polar lipid containing material (PLCM) was added to sucrose and stirred in a Thermomix (3 minutes at 2.5 speed). Mixing continued in Thermomix (2 minutes at 4 speed). Cocoa powder was added and mixing continued (5 minutes at 5.5 speed in Thermomix; T≈55° C.). The powder was divided into two equal portions and each portion processed in the following way. The powder was milled in Thermomix (2 minutes at maximum speed; T≈85° C.) then the powder was redistributed and any lumps were broken and the milling was continued (30 seconds at maximum speed; T≈85° C.). Two batches were recombined to make one batch (^{˜}1 kg).

### Agglomeration

Agglomeration of powder in a Glatt AG fluid-bed agglomerator took approximately 10 minutes. Powder was heated in a fluidized bed using hot air while water was sprayed onto the powder (Tᵢₙₗₑₜ^{˜}90° C.; 200 g total in ^{˜}7 minutes). The powder was dried in the same fluidized bed (Tₒᵤₜₗₑₜ falls to ^{˜}35° C.). Once dry the powder was cooled in the same fluidized bed (Tᵢₙₗₑₜ^{˜}′40° C. for ^{˜}3 minutes).

Powders were sieved (2 mm), packaged and stored in plastic jars at 25° C. for analysis.

| | | | Cocoa | % of total |
|---|---|---|---|---|
| | Sucrose | Polar lipid | powder | lipid as |
| Sample | (g) | containing material | (g) | glycolipid |
| 1 | 790 | 6 g PL 40 + 4 g | 200 | 4.6 |
| | | PL 15 oat oil | | |
| 2 | 790 | 8 g PL 40 + 2 g | 200 | 5.4 |
| | | PL 15 oat oil | | |
| 3 | 790 | 10 g PL 40 oat oil | 200 | 6.1 |
| 4 | 790 | 10 g Cargill | 200 | ~3 |
| (comparative) | | sunflower lecithin | | |
| 5 | 790 | 10 g Bunge | 200 | ~3 |
| (comparative) | | sunflower lecithin | | |

| | Particle size | | 7-12 Days | | | 2 Months | | |
|---|---|---|---|---|---|---|---|---|
| | D_{4, 3} | % Fines | 45 | 3 | Time | 45 | 3 | Time |
| | (μm) | (<91.2 μm) | s | min | (s) | s | min | (s) |
| Sample 1 | 281 | 10.07 | A | A | 10 | A | A | 35 |
| Sample 2 | 716 | 1.92 | A | A | 8 | A | A | 23 |
| Sample 3 | 413 | 5.94 | A | A | 6 | A | A | 11 |
| Sample 4 | 329 | 9.37 | A | A | 8 | B | B | — |
| Sample 5 | 335 | 7.87 | A | A | 8 | B | B | — |

Powders with polar lipids coming from oat oil (samples 1, 2 and 3) and polar lipids coming from sunflower lecithin (samples 4 and 5) all showed good wettability at 7-12 days. However, after storage for 2 months the powders with oat oil polar lipids demonstrated better wettability.

1. Powdered beverage comprising lipids wherein at least 3.5 wt. % of the lipids are glycolipids and wherein the lipids comprise a fat having a melting point above 20° C.

2. A powdered beverage according to claim 1 comprising fat wherein at least 40 wt. % of the fat is surface free fat.

3. A powdered beverage according to claim 1 wherein the glycolipids originate from oats.

4. A powdered beverage according to claim 1 wherein the powder is an agglomerated powder having a particle size distribution D_{4,3} greater than 250 microns.

5. A powdered beverage according to claim 1 comprising at least 1 wt. % protein.

6. A powdered beverage according to claim 1 wherein the powdered beverage is a cocoa beverage.

7. Process for manufacturing a powdered beverage, the process comprising preparing a composition comprising protein, carbohydrate and lipids, wherein at least 3.5 wt. % of the lipids are glycolipids and at least 30 wt. % of the lipids are fat having a melting point above 20° C.

8. A process according to claim 7 wherein the fat is heated to a temperature above its melting point.

9. A process according to claim 7 comprising
a. mixing a protein-containing powder, fat and glycolipids; and
b. agglomerating the powder mix.

10. A process according to claim 7 comprising
a. mixing a protein-containing powder and fat to form a powder mix;
b. agglomerating the powder mix; and
c. coating the powder mix with glycolipids.

11. A process according to claim 7, comprising
a. dissolving or dispersing a carbohydrate, protein-containing powder and fat in water;
b. spray-drying the solution or dispersion to form a powder; and
c. coating the powder with glycolipids.

12. A process according to claim 7, comprising
a. dissolving or dispersing a carbohydrate, protein-containing powder, fat and glycolipids in water;
b. spray-drying the solution or dispersion to form a powder; and
c. agglomerating the powder.

13. A method to reduce the reconstitution time of a beverage powder using a glycolipid.

14. A method according to claim 13 wherein the beverage powder is a cocoa beverage.
